(19) United States
(12) Patent Application Publication
(10) Pub. No.: US 2024/0286505 A1
(43) Pub. Date: Aug. 29, 2024

(54) SUPPLY CABLE

(71) Applicant: Robert Bosch GmbH, Stuttgart (DE)

(72) Inventors: Daniel Meyer, Stuttgart (DE); Markus Schreiber, Markgroeningen (DE); Martin Schmidt, Stuttgart (DE); Michael Loercher, Korntal-Muenchingen (DE)

(21) Appl. No.: 18/573,485

(22) PCT Filed: Jun. 24, 2022
(86) PCT No.: PCT/EP2022/067358

§ 371 Date: Jan. 5, 2024

(30) Foreign Application Priority Data
Jun. 25, 2021 (DE) 10 2021 206 606.2

(51) Int. Cl. B60L 53/18; B60L 53/16

(52) U.S. Cl. CPC B60L 53/18; B60L 53/16

(57) ABSTRACT

The present invention relates to a supply cable (10) for electrically connecting a vehicle (12) both to an energy supply device (16) and to a consumer, comprising: —a connecting line (13) having a coupling (6); —a primary connector (14) which is electrically coupled to the connecting line (13) and which has a vehicle connection point (14A) for releasably electrically connecting to the vehicle (12); —a secondary connector (15A) which, depending on its type, is provided either for releasably electrically connecting to the energy supply device (16) or to the consumer; wherein the vehicle connection point (14A) has at least one transmission element by means of which a status line of the supply cable (10) can be connected to the vehicle (12), the status line being designed to have a first characteristic indicating readiness of the supply cable (10) to transmit electrical energy to the vehicle (12) and to have a second characteristic indicating readiness of the supply cable (10) to draw electrical energy from the vehicle (12), and wherein the at least one secondary connector (15A) is designed to set either the first characteristic or the second characteristic at the status line and/or the primary connector (14) has a switchover unit by means of which either the first characteristic or the second characteristic can be set.

### BACKGROUND

The present invention relates to a supply cable for charging a battery of a vehicle and drawing electrical energy from the battery of the vehicle.

Electric vehicles typically comprise an electrical energy storage unit, e.g. a traction battery, that provides the electrical energy for the engine. If this electrical energy storage unit is fully or partially discharged, then the energy storage unit of the electric vehicle must, e.g., be connected to the power grid or another power source at a charging point and recharged.

There are currently several opportunities in the market for charging electric vehicles. For example, electric vehicles can be stored at publicly accessible charging columns or charging station or being charged in the private area at a normal power outlet. Two basic principles are present in this context.

On the one hand, it is possible to charge at permanently installed charging stations (charging columns or so-called wall boxes). To this end, either a charging cable with a charging plug is inserted into the charging station or the charging cable is already fixedly connected to the charging station. Such a charging cable is also referred to as a passive charging cable and is merely or substantially used to direct the power from the charging station to the energy storage unit arranged in the vehicle. If the user wants to charge its energy storage unit at such a charging station, then the user must first identify and authorize themselves. The identification is e.g., performed by reading an RFID card, a credit card, or by connecting to an app installed on the requestor's cell phone or the like. Authorization is also performed (by way of example only) using an app or via a payment information stored on the RFID card. Finally, after identification and authorization are completed, the charging station takes over the charging current. The charging cable has the sole function of establishing the electrical connection to the electric vehicle-hence the designation “passive charging cable”. The disadvantage thereby is the complex process consisting of identification, authorization, and inclusion or shutting off the charging current through the charging column. Processes that the driver or the requestor must initiate. Furthermore, at least one signal line can be provided in the charging cable, via which the charging station communicates with the vehicle and via which, e.g., the requested charging power or current intensity can be exchanged between the vehicle and the charging station.

On the other hand, it is possible to charge on what are referred to as continuous power outlets, e.g. a normal household power outlet. To this end, a charging cable with a controller integrated in the connecting line (ICCB: In-Cable Control-Box) is conventionally required. The ICCB has the function of verifying, via the communication with the electric vehicle, the readiness to charge the vehicle, switch on the current when required, and permanently monitor the safe electrical connection to the electric vehicle and also switch off in the event of a fault. One disadvantage in this case is the control integrated into the connecting line between the two charging plugs, which results in more complex handling (box on the cable on the other side: “charging brick”) and also an increased puff on the plug of the charging cable, especially with power outlets high above the floor.

Regardless of the respective charging method—whether at the charging station or on continuous power outlets—the driver expects a charging process that is both fast and straightforward on the one hand and simple on the other.

In addition, there may be situations in which electricity or electrical energy is to be drawn from the vehicle or its battery. This may be the case if, e.g., a further another vehicle whose energy storage unit is depleted is to be given “starting aid”. Or, power is to be supplied to an electrical consumer in a location where there is currently no (household) power outlet, e.g., for working on a garden plot or when camping.

The driver or enable users of an electric vehicle to more easily charge their vehicle. At the same time, there may be a need to enable a driver or user of an electric vehicle to easily draw energy from their vehicle. To this end, there may be a need to easily realize these different use cases with little weight and storage space requirements as well as at low cost

### SUMMARY

The supply cable according to the invention enables various configurations in order to cover different requirements. A user can in this case use the supply cable on the one hand to supply electrical energy to a vehicle and, on the other hand, to draw electrical energy from the vehicle. User interventions are not necessary or limited to a minimum. The user can therefore cover a variety of use cases by reconfiguring the same supply cable.

The supply cable is used to electrically connect a vehicle, in particular an energy storage unit of a vehicle, to both an energy supply device and a consumer requiring electrical power. Charging and discharging can, e.g., be optionally enabled. The supply cable comprises a connecting line, a primary connector, and a secondary connector. The connecting line in turn comprises a coupling designed for electrical connection to the secondary connector. Various types of secondary connectors are provided, each secondary connector being provided for either a releasable electrical connection with the energy supply device or with the electrical consumer, depending on the type thereof. The coupling of the connecting line is therefore preferably designed to be optionally releasably electrically connected to one of the various types of secondary connector.

The primary connector is electrically coupled to the connecting line or releasably connectable (e.g., via a further coupling arranged on the connecting line). The primary connector also comprises a vehicle connection point for releasable electrical connection to the vehicle, in particular the energy storage unit. At the vehicle connection point, at least one transmission element is provided via which a status line of the supply cable is wired or can be wirelessly connected to the vehicle. Preferably, the at least one transmission element is comprised of electrical contact elements, e.g. electrical contact pins or contact sockets, or means, e.g. coils, for wireless energy transmission.

On the one hand, the status line enables the vehicle to detect the connection to the supply cable, in particular the primary connector. In addition, it is provided that the vehicle receives information about the configuration of the supply cable, and thus the user-intended use of the supply cable, via the status line. In particular, a first characteristic and a second characteristic can be displayed or indicated via the status line. The status line is therefore designed to have a first characteristic and a second characteristic. The first characteristic indicates a readiness of the supply cable to transmit electrical energy to the vehicle. The second characteristic indicates a readiness of the supply cable to draw electrical energy from the vehicle. If the vehicle or the energy storage unit is intended to be charged, then the supply cable can be configured accordingly by selecting the appropriate secondary connector that is connected to the coupling—the status line then has the first characteristic or can display this characteristic to a vehicle coupled to the additional line or such a vehicle can read this first characteristic. If, on the other hand, an electrical consumer is intended to be operated with electrical energy from the vehicle or the energy storage unit (i.e. electrical energy is to be drawn from the vehicle's energy storage unit), then the supply cable can also be configured appropriately by selecting the corresponding secondary connector—the status line then has the second characteristic or can display this to a vehicle coupled with the additional line or such a vehicle can read this second characteristic.

The setting of the first characteristic and the second characteristic can be performed automatically and/or manually. It is thus provided that the at least one secondary connector is designed to set either the first characteristic or the second characteristic at the status line, depending on the type thereof. Alternatively or additionally, the primary connector comprises a switchover unit through which either the first characteristic or the second characteristic can be set at the status line.

If the setting of the first characteristic and the second characteristic occurs by connecting the various secondary connectors to the coupling, no further activities are necessary by the user. Rather, the user need only attach the appropriate secondary connector for the desired application, and the supply cable then provides or features the corresponding characteristic. In other words, when the primary connector is connected to the vehicle, the desired function is communicated to the vehicle via the status line or the vehicle can read in or determine the corresponding characteristic of the status line. Advantageously, it can, e.g., be provided that no own power source, e.g. a battery, is necessary in the supply cable to provide the respective characteristic of the status line. If, however, the first characteristic and the second characteristic are set manually by the changeover unit, then it is particularly preferable for the supply cable to distinguish between various charging and energy drawing cases (e.g., the type of charging/drawing connector or the maximum possible current) by itself because the user simply selects the secondary connector suitable for the intended charging situation from several secondary connectors suitable for charging. The switchover unit therefore need only distinguish between two cases, i.e., charging the vehicle and drawing energy from the vehicle. A switchover unit, which switches between the various charging cases, e.g. charging on a household power outlet and charging on a charging station or wallbox, is therefore not absolutely necessary, but nonetheless possible.

The secondary connector is preferably designed as a first secondary connector and/or a second secondary connector and/or a third secondary connector and/or a fourth secondary connector. All of these various types of secondary connector connect to the at least one coupling of the connecting line to achieve various configurations of the supply cable.

The first secondary connector is in particular designed to electrically contact an energy supply device having its own charging control logic. The first secondary connector is, e.g., a Type 2 plug (charging plug) that enables electrical connection to a charging station or wallbox. The first secondary connector can, e.g., be designed to emboss or set the first characteristic in the status of the status line coupled to the connecting line. In other words, the status line then features the first characteristic.

The second secondary connector is in particular designed to electrically contact an energy supply device without its own charging control logic and/or with a continuous supply of electrical voltage. The second secondary connector is, e.g., a Schuko plug for electrically connecting to a household power outlet or a three-phase power outlet, in which case the exact mechanical configuration of this purely exemplary Schuko plug depends on the country or region. The second secondary connector can, e.g., be designed to adjust or set the first characteristic in the status of the status line coupled to the connecting line. In other words, the status line then has the first characteristic.

In particular, the third secondary connector comprises a power outlet for electrical plug-in connection with the consumer. Energy can therefore be drawn from the vehicle in order to operate the consumer. The consumer can (by way of example only) be Schuko power outlet to which, e.g., common household appliances, tools, or outdoor equipment can be electrically connected. However, the consumer can in principle also be a three-phase power outlet. The third secondary connector can, e.g., be designed to adjust or set the second characteristic in the status of the status line coupled to the connecting line. In other words, the status line then has the second characteristic.

The fourth secondary connector is in particular designed to electrically contact another vehicle. The fourth secondary connector is, e.g., a Type 2 plug (e.g., a charging plug for an electric vehicle) provided for electrical connection to a vehicle. This enables energy to be drawn from the one vehicle and supplied to the other vehicle. The fourth secondary connector can, e.g., be designed to adjust or set the second characteristic in the status of the status line coupled to the connecting line. In other words, the status line then has the second characteristic.

The vehicle connection point of the primary connector advantageously comprises a transmission element via which a communication line of the supply cable is wired or can be wirelessly connected to the vehicle. Similar to the transmission element for connecting the status line, the transmission element for connecting the communication line is preferably designed differently. It can, e.g., be a contact element, e.g. a plug contact or a contact socket or, e.g., a coil for wireless signal transmission. Other implementations of the transmission element for signal transmission are also possible.

The first secondary connector preferably comprises an infrastructure connection point, e.g. a Type 2 connection point or Type 2 plug, for the connection to the energy supply device. In this case, the communication line is established directly between the vehicle connection point and the infrastructure connection point. As a result, direct communication between the charging control logic of the energy supply device and the vehicle is enabled. Therefore, the vehicle and energy supply device can, e.g., negotiate a charging current and control the charging process. In this case, the supply cable is a non-intelligent charging cable that is only used for signal transmission and power transmission and does not independently perform these transmissions. In a particularly advantageous embodiment, the infrastructure connection point of the first secondary connector connects a further status line, which is in particular separate from the previously described status line or is electrically connected to the previously described status line, to the energy supply device. This also indicates to the energy supply device that the supply cable is electrically connected to it. In addition, further information about the further status line can be exchanged with the energy supply device, in particular with the charging control logic of the energy supply device. Such further information can, e.g., include a maximum current carrying capacity of the supply cable.

In the event that the further status line is electrically separated from the status line, it can be provided that the status line optionally comprises or provides the first and second characteristics, as the case may be, which can be read by the vehicle and that the further status line comprises one or more other characteristics, which can be read by the energy supply device. In the respective plug faces, the status line and the further status line can be arranged in the same position. In this case, the status line and additional status line are merely not electrically connected to each other within the supply cable.

Furthermore, it is preferably provided that the primary connector and/or the connecting line comprises a control unit and a bypass switch. These components advantageously enable the supply cable to act intelligently and communicate with the vehicle on its own. To this end, the control unit is designed to communicate with the vehicle. Communication between the vehicle and the control unit makes it possible to, e.g., negotiate a charging current intensity and/or control the charging process, which is similar to the case of communication between the vehicle and the charging control logic of the energy supply device. However, in the described configuration, the charging control logic of the energy supply device is not necessary. Therefore, charging is, e.g., also possible via household power outlets. However, the control unit can in principle also be used for communication with a wall-box or a charging station. The bypass switch is designed to disconnect at least one connection point of the control unit from the communication line in a first switching status and connect the at least one connection point of the control unit to the communication line in a second switching status. In particular, it can be achieved that a connection between the control unit and the vehicle connection point of the primary connector via the communication line is established in the second switching status. In the first switching status, a communication line between the vehicle connection point of the primary connector and the secondary connector is preferably established by bypassing the control unit or by bypassing the connection point or connection points of the control unit that can send and/or receive control signals. Therefore, in the first switching status, direct communication between the vehicle and the energy supply device is enabled, whereas in the second switching status communication between the vehicle and the control unit is achieved. In the second switching status, it can be provided that the control unit is additionally connected to the secondary connector with a further connection in order to receive communication signals from an existing charging control logic or other control of the energy supply device (e.g., when used at switchable power outlets and/or wall boxes or charging columns, in which the control unit is intended to serve as a broker between the vehicle and the charging control logic of the energy supply device). Communication with the vehicle in the second switching status preferably always proceeds through or via the control unit of the supply cable. The bypass switch remains in the first switching status in the absence of actuation. The second secondary connector is designed to actuate the bypass switch in order to switch to the second switching status. The control unit (only) therefore becomes active when it is needed, which is, e.g., indicated by the presence of the second secondary connector. The second secondary connector is, e.g., required when the energy supply device does not have charge control logic for controlling the delivery of power or the charging control logic of the energy supply device is or cannot be used for direct communication with the vehicle. For example, when the second secondary connector is designed to be connected to a Schuko power outlet. Or, if the secondary connector is designed to be connected to another vehicle to be given “starting aid” or to be charged by way of the vehicle.

Particularly advantageously, in the first switching state of the bypass switch, an electrical connection between the at least one connection point of the control unit and the coupling and/or the vehicle connection point is interrupted and, at the same time, the communication line between the vehicle connection point and the coupling is established without interruption. In the second switching status of the bypass switch, the control unit is electrically switched between the vehicle connection point and the coupling. The control unit can therefore be supplied with electrical power in the second switching status in order to become active. In the first switching status, the control unit is preferably electrically separated from the secondary connector (at least those connection points of the control unit that can send control signals from the secondary connector and/or from communication with the vehicle) and the communication line is established or at least established by bypassing the control unit without the control unit being able to send control signals to the communication line.

In a particularly preferred embodiment, an electronic component, e.g., a microcontroller or an ASIC or the like, is provided comprising the control unit and the bypass switch. For example, an integrated circuit is provided thereby, as a result of which an additional (discrete) switch can be omitted as a bypass switch. The construction of the supply cable is simplified thereby. Likewise, a space requirement is minimized.

The second secondary connector advantageously comprises a voltage supply and a plug-in connector for connection to the energy supply device. The voltage supply is electrically coupled to the plug-in connector and, e.g., an AC/DC converter or AC/DC converter. It is preferably provided that when an electrical voltage is applied to the plug-in connector by the energy supply device, an electrical voltage is also applied to the voltage supply, which in turn provides an electrical supply voltage. The electrical supply voltage can be applied to the output to the control unit, in particular via the communication line or the status line, and/or to the bypass switch. If the supply voltage is applied to the bypass switch, it is switched to the second switching status. The supply voltage is therefore used as a trigger for the switching the bypass switch. If the supply voltage is applied to the control unit, then the control unit preferably becomes active and takes over communication with the vehicle. Particularly preferably, a combination is performed such that the bypass switch is first switched to the second switching status by the supply voltage in order to connect the control unit to the voltage supply. This enables electrical power to be supplied to the control unit through the voltage supply. The second secondary connector further preferably comprises a switching unit controllable by the control unit. Via the switching unit, an electrical connection between the plug-in connector and the coupling can be switched on and off, in particular to control a charging operation. It is then preferably provided that the switching unit disconnects the electrical connection between the plug-in connector and the coupling in a normal status and is only actuated by the control unit in order to make said electrical connection for the charging operation. Therefore, no electrical voltage is applied to the coupling and to the vehicle connection point of the primary connector until a charging operation has been agreed and negotiated between the vehicle and the control unit.

In a particularly advantageous embodiment, the primary connector can be used as a fourth secondary connector of another supply cable, which means that no additional plug-in adapter needs to be carried in a breakdown situation if another vehicle is carrying a similar supply cable with a primary connector. The fourth secondary connector is used to electrically contact a vehicle and performs the same function as the primary connector in this regard. In such a constellation, the supply cable then comprises two primary connectors, one of which serves as the (fourth) secondary connector. One vehicle serves as an energy supply device for drawing energy, and the other vehicle serves as a vehicle that is being charged. If the primary connector is to be used as the fourth secondary connector together with another primary connector, then the control unit is to be activated such that it can act as a charging control logic (e.g., against the vehicle to be charged). As a result, it is possible for a further energy storage unit of a further vehicle to be recharged by the energy storage unit of the vehicle. The primary connector to be used as the fourth secondary connector therefore has the option of being switched to a corresponding status via the switchover unit or an additional switchover unit. In addition to setting the first characteristic (“charging”) at the status line, this status also means switching the bypass switch to the second switching status and/or activating the control unit (this enables this primary connector to communicate with the vehicle to be charged). For this purpose, the switchover unit or the additional switchover unit of the primary connector is designed to switch the bypass switch to the second switching status and/or activate the control unit in addition to setting the first characteristic at the status line. The control unit is therefore active and enables communication with the further vehicle in order to control a charging operation for that further vehicle. The primary connector is therefore usable as the fourth secondary connector of another supply cable. It should be noted that for such a configuration, the side of the supply cable connected to the power-dispensing vehicle can then be configured, e.g., via the switchover unit or the additional switchover unit, such that the status line connected to the power-dispensing vehicle has the second characteristic (“dispensing energy”).

One embodiment provides that the fourth secondary connector comprises an additional vehicle connection point for connection to the further vehicle. This is, e.g., a Type 2 connection point.

The fourth secondary connector either comprises a further control unit, the fourth secondary connector providing a separate additional communication line from the communication line between the further control unit and the additional vehicle connection point;
or the communication line runs uninterrupted between the fourth secondary connector and the primary connector to enable direct communication between the vehicle and the further vehicle.

In the first case, the additional communication line is used to communicate between the further control unit and the further vehicle in order to, e.g., control a charging operation. In particular, the further control unit in its functionality substantially corresponds to the control unit of the primary connector, since the charging situation is the same as or at least similar to the charging situation for the control unit of the primary connector when connecting the supply cable to an energy supply device without its own charging control logic. The fourth secondary connector can, e.g., be used to connect to the battery of the further vehicle (to be charged) in a vehicle-to-vehicle energy transfer situation.

In the second case, the charging controller is negotiated directly between the two vehicles. Advantageously, the further control unit can be omitted. It can be advantageous for a data protocol suitable for communication between the vehicles to be available for this negotiation of the discharging/charging operation.

One embodiment provides that the first characteristic and/or the second characteristic are realized or formed by a passive electrical component of the primary connector or the secondary connector. The passive electrical component can, e.g., be an electrical resistor. For example, two different magnitudes of electrical resistance therefore indicate the first characteristic or the second characteristic. Alternatively or additionally, it is preferably provided that the first characteristic and the second characteristic are realized by signals from a control device of the primary connector or secondary connector. The passive electrical component can also be realized by said control device. The control device of the primary connector can in particular be realized by the control unit of the primary connector. Displaying or providing the first characteristic and the second characteristic can preferably be part of a handshake that occurs independently between a control device of the supply cable and the vehicle when establishing the connection between the vehicle and the vehicle connection point of the primary connector.

One embodiment provides that the first characteristic and/or the second characteristic preferably have one or more sub-characteristics. The sub-characteristic or the sub-characteristics preferably indicate, e.g., a maximum current carrying capacity of the supply cable. Therefore, in addition to distinguishing in which direction the power is to flow with respect to the vehicle, further information can also be transmitted via the status line.

Preferably, it is provided that the supply line or connecting line comprises an additional coupling. The additional coupling is used to connect the primary connector to the supply line or the connecting line. It is provided that electrical conductors of the connecting line for power transmission and/or signal transmission extend continuously between the coupling and the additional coupling. In particular, said electrical conductors are not interrupted. In this particular case, interrupting means that no further electrical components are connected between the coupling and the additional coupling (i.e., no ICCB as well). Rather, the electrical conductors in particular run directly and continuously from the coupling to the additional coupling such that e.g., a continuous copper conductor is present per conductor. Therefore, the supply line or connecting line advantageously around a pure connecting element without any active or passive electronic components. The supply line or connecting line is thereby designed to be very simple and inexpensive. The use of the coupling and the additional coupling also makes it possible to replace the supply line or connecting line in the event of a defect, in which case it is not necessary to replace the primary connector or first connection device and/or secondary connector or second connection device at the same time. This is advantageous for users of the supply line or connecting line because they save significant costs if they only use the favorable supply line or replace the connecting line if it is damaged or overly dirty. Given that the primary connector and/or the secondary connector comprise active and/or passive electronic components, the financial outlay for replacing the supply line or connection line in question can be minimized. The primary connector advantageously comprises an additional connection point that can be electrically connected to the additional coupling. In this way, an electrical connection can be established between the vehicle connection point and/or the control unit and/or the bypass switch and the electrical conductors of the supply line or connection line. The electrical connection between the additional coupling of the supply line and in particular the connecting line and the additional connection point of the primary connectors is performed in a wireless or wired manner and is advantageously designed to be releasable indirectly or directly. The supply line or connecting line and the primary connector are therefore either permanently and therefore non-destructively releasably connected to each other or alternatively separately coupled to each other.

The primary connector preferably comprises a communication unit. The communication unit is preferably a radio communication interface. The radio communication interface (e.g., a WLAN module or a mobile radio module, e.g., in the 4G-, 5G-, 6G-Standard, or a Bluetooth interface, etc.) particularly preferably enables communication with a user terminal (e.g., a cell phone, the vehicle, etc.) and/or the Internet.

Alternatively or additionally, it is preferably provided that the primary connector comprises a display and/or input module which is, e.g., preferably designed to display the current flow or to input a desired charging current or a current flow.

Alternatively or additionally, the primary connector preferably comprises an energy measurement module designed to determine an electrical energy passed through the supply cable. The energy measurement module (e.g., by means of a current sensor, e.g. a Hall sensor) measures the current flowing through the supply cable in a particularly advantageous way in order to determine a charging power together with the applied electrical voltage and, taking into account the duration of the current flow, determine the energy that has flowed. It is therefore possible to quantify the electrical energy flowing between the energy supply unit and the vehicle (also depending on the direction), in particular in order to simplify a billing process and/or to give the user an overview of the energy supplied to (or discharged from) the vehicle (on balance), for example.

Alternatively or additionally, it is advantageously provided that the primary connector comprises an authentication module. The authentication module is in particular used to authenticate with the energy supply device, in order to thus display an authorization, e.g., for drawing of energy. In addition, an accounting can be processed by means of the authentication module, so the user need only have their personal supply cable or personal primary connector available, e.g. via a database, stored in an accounting system. To calculate the amount of energy flow, e.g. the energy drawn from the energy supply device, there is advantageously independent communication between the authentication module and the energy supply device. In this way, the accounting process between users of the power connection point and the owner of the power connection point, e.g. a municipal utility or a utility, is simplified. For example, the payment process for a charging process is thus simplified for the user. The need for complex authentication using various apps on a cell phone, etc., or by way of special charging cards for each power supplier is eliminated as a result.

In one preferable embodiment, the secondary connector comprises a temperature monitoring module. The temperature monitoring module is configured to output a temperature information signal to the control unit depending on a temperature detected in the secondary connector. Alternatively or additionally, the temperature monitoring module is designed to set and/or interrupt a current flow through the secondary connector. In this way, the temperature monitoring module in particular enables the maintenance a predefined temperature range. Therefore, on the one hand, it is provided that the temperature monitoring module outputs a temperature information to the control unit so that the control unit can take into account said information about the temperature in the secondary connector during the charging process. The temperature information can, e.g., be a temperature information signal, e.g., a value which only comprises, e.g., two or three stages, whereby more stages are also possible. A first step can in this case correspond to a status line “temperature is within the normal range”. A second step can, e.g., correspond to a status “temperature is elevated but not yet critical”, and a third step can, e.g., correspond to a status “temperature is critical”. Said temperature therefore need not be the determined temperature itself. On the other hand, the temperature monitoring module can, e.g., also be configured to limit or interrupt the charging current on its own. It can be provided that these two possibilities, i.e. the transmission of temperature information and the autonomous reduction or interruption of the charging current are provided either alternatively or cumulatively.

In one particularly advantageous embodiment, it is provided that the temperature monitoring module comprises an evaluation circuit connected to at least one temperature sensor arranged in the secondary connector. The evaluation circuit preferably provides a temperature signal, a temperature information signal, or a status signal depending on the determined temperature, which, in particular via the connecting line or at least one electrical conductor of the supply line or connecting line, is transmitted to the control unit of the primary connector (or in wireless manner, e.g. via an electrical conductor provided as a signal line). By means of the control unit, the power demand from the energy supply device or a power output to the consumer can be reduced and/or interrupted depending on the status signal. Therefore, no direct influence of the evaluation circuit on the charging current is in particular provided. It is instead provided in particular that the evaluation circuit informs the control unit of a current temperature status by means of the aforementioned status signal. The status signal can, e.g., comprise multiple stages, each stage corresponding to a pre-determined temperature range. In particular, a first status signal can be output if the temperature of the second connection device is within a normal range. A second status signal can be output if the temperature of the secondary connector is within a warning range in which a further increase in the temperature is intended to be avoided. A third status signal can in particular be output if the temperature in the secondary connector has exceeded a predefined maximum threshold. Alternatively or additionally, the evaluation circuit is designed to interrupt the current flow, e.g. the charging current, independently when the aforementioned maximum threshold is exceeded, whereby a redundancy regarding the temperature safety is advantageously provided. In this case, the control unit is not needed for the interruption of the current flow, but it can continue to be redundantly active.

The term “charging” is in this context understood as an example of an energy transfer between the vehicle and the power supply device. During charging, energy is in this case supplied to the vehicle or the energy storage unit thereof.

The term “discharging” is in this case understood as another example of energy transfer between vehicle and power supply device. Energy is drawn from the vehicle or the energy storage unit thereof during discharging.

### BRIEF DESCRIPTION OF THE DRAWINGS

Exemplary embodiments of the invention are described in detail hereinafter with reference to the accompanying drawings. In the drawings:

FIG. 1A is a schematic illustration of a vehicle connected to an energy supply device via a supply cable according to an exemplary embodiment of the invention with the supply cable featuring a first configuration,

FIG. 1B is a schematic illustration of a vehicle connected to an energy supply device via a supply cable according to an exemplary embodiment of the invention with the supply cable featuring a second configuration,

FIG. 1C is a schematic illustration of a vehicle connected to an energy supply device via a supply cable according to an exemplary embodiment of the invention with the supply cable featuring a third configuration,

FIG. 1D is a schematic illustration of a vehicle connected to an energy supply device via a supply cable according to an exemplary embodiment of the invention with the supply cable featuring a fourth configuration,

FIG. 2A a first schematic diagram of the structure of the supply cable according to the exemplary embodiment of the invention with the first configuration and the second configuration of the supply cable being shown,

FIG. 2B a first schematic diagram of the structure of the supply cable according to the exemplary embodiment of the invention with the third configuration and the fourth configuration of the supply cable being shown,

FIG. 3A is a second schematic diagram of the structure of the supply cable according to the exemplary embodiment of the invention with the first configuration and the second configuration of the supply cable being shown,

FIG. 3B is a second schematic diagram of the structure of the supply cable according to the exemplary embodiment of the invention, with the third configuration and the fourth configuration of the supply cable being shown,

FIG. 4 is a third schematic diagram of the structure of the supply cable according to the exemplary embodiment of the invention with the third configuration and the fourth configuration of the supply cable being shown, and

FIG. 5 is a fourth schematic representation of the structure of the supply cable according to the exemplary embodiment of the invention.

All of the drawings are merely schematic representations of the device according to the invention or its components according to exemplary embodiments of the invention. In particular, distances and size relations are not reproduced to scale in the drawings. In the various drawings, corresponding elements are provided with the same reference characters.

### DETAILED DESCRIPTION

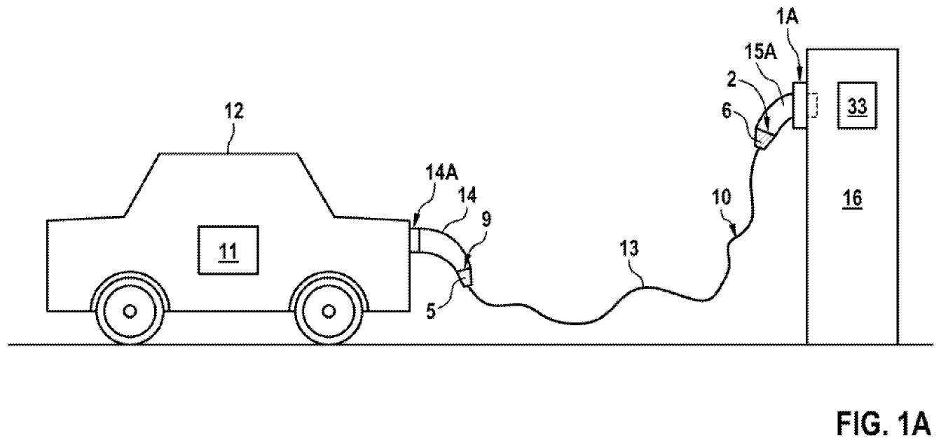

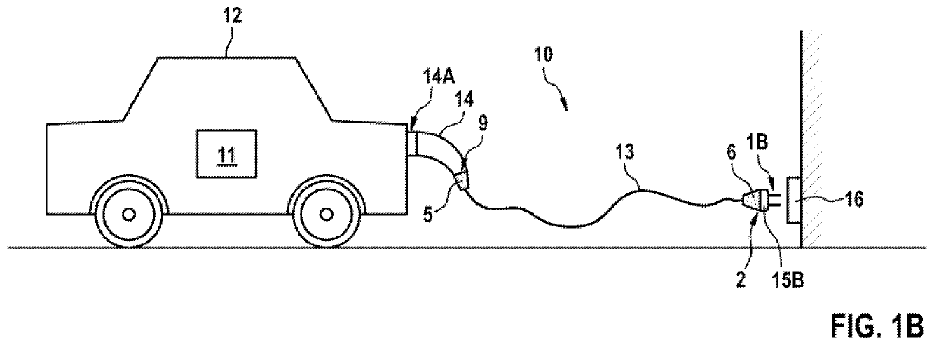

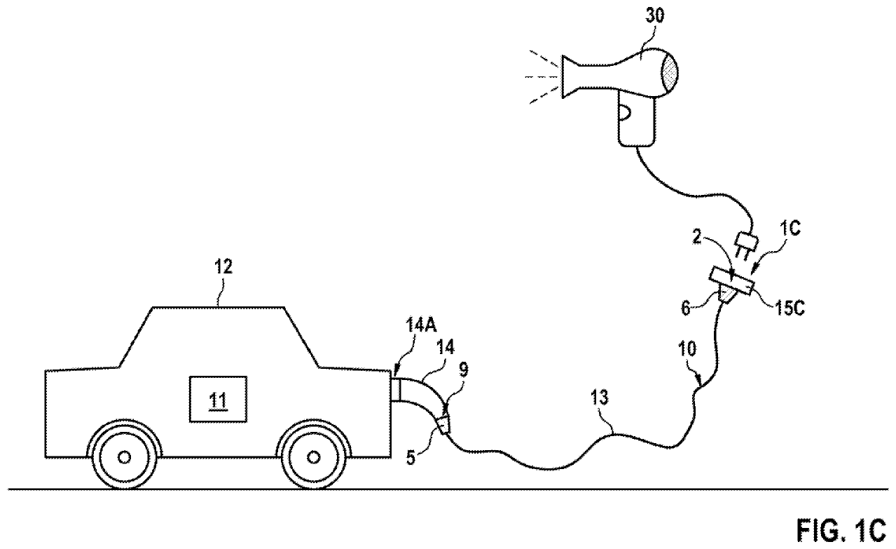

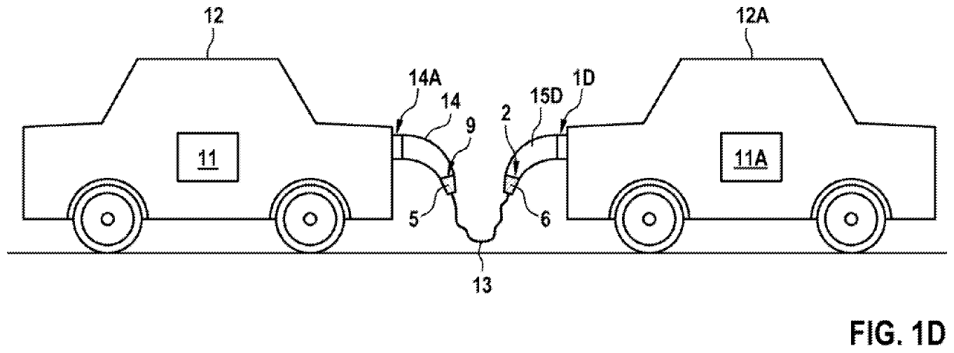

FIG. 1A schematically shows a vehicle 12 that is, e.g., a hybrid or electric vehicle and that comprises an energy storage unit 11. The energy storage unit 11 is intended to be charged via an energy supply device 16, whereby the energy supply device 16 in the case shown in FIG. 1A is a charging column enabling charging using three-phase AC voltage. In addition, the energy supply device comprises its own charging control logic 33, which can control a charging operation. A supply cable 10 according to an exemplary embodiment of the invention is provided for connecting the energy supply device 16 and the energy storage unit 11 or vehicle 12.

The supply cable 10 comprises a primary connector 14 as well as a secondary connector 15A, 15B, 15C, 15D (see FIGS. 1A through 1D), with a first secondary connector 15A being shown in FIG. 1A. The supply cable is therefore in a first configuration. There is a supply line or connecting line 13 between the primary connector 14 and the first secondary connector 15A. The primary connector 14 is used for the electrical connection with the vehicle 12 and specifically with the energy storage unit 11. The second secondary connector 15A is used for connection to the energy supply device 16 with its own charging control logic 33.

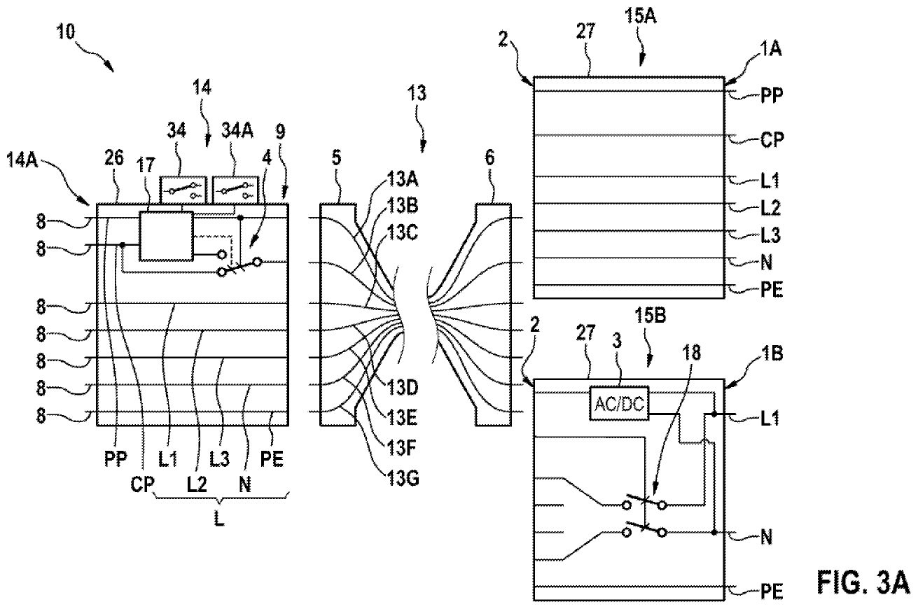

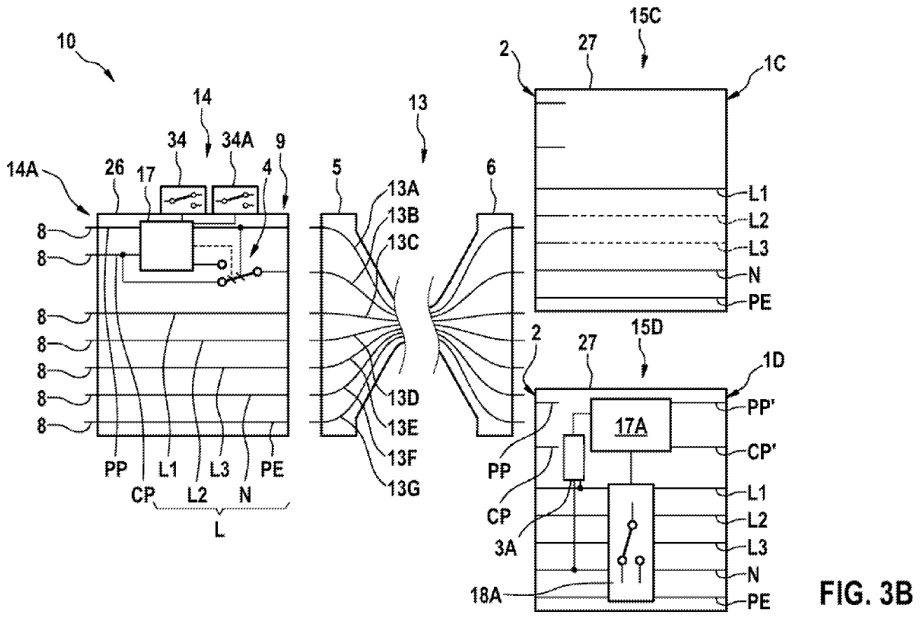

The primary connector 14 comprises a vehicle connection point 14A provided for indirectly or immediately releasable wireless or wired electrical connection to the vehicle 12 or energy storage unit 11. The vehicle connection point 14A in turn preferably comprises a plurality of transmission elements 8 (see FIGS. 3A, 3B), which are more preferably contact elements, e.g. plug contacts or female contacts, or e.g. induction coils to make the electrical connection. The electrical connection can be made either wired or wireless, for example inductive or capacitive. In the electrically connected status, (electrical) energy can be transmitted between the primary connector 14 and the opposite connection point of the vehicle 12 connected thereto.

In the embodiment shown, the primary connector 14 also comprises an additional connection point 9 via which a wireless and/or wired electrical connection with an additional coupling 5 of the connecting line 13 can be directly or indirectly releasably produced. In an alternative design, the additional connection point 9 as well as the additional coupling 5 can be omitted so that the connecting line 13 is directly attached to the primary connector 14 and is not non-destructively releasable from the same.

The supply cable 10 can be coupled to various types of secondary connectors 15A, 15B, 15C, 15D. The first secondary connector 15A shown in FIG. 1A is used to electrically connect the supply cable 10 to the energy supply device 16, which has its own charging control logic 33 and which, e.g., enables three-phase charging. The charging infrastructure as energy supply device 16 can therefore communicate directly with the energy storage unit 11 and/or the vehicle 12. The first secondary connector 15A comprises an infrastructure connection point 1A and a cable connection point 2, in which case the infrastructure connection point 1A is designed for electrical connection to the energy supply device 16. The cable connection point 2 is used for connection to the connecting line 13. The connecting line 13 comprises a coupling 6 for this purpose, whereby the coupling 6 and the cable connection point 2 can be releasably electrically connected. FIGS. 1B to 1D describe further various types of secondary connector 15A, 15B, 15C, 15D, in FIG. 1B a second secondary connector 15B, in FIG. 1C a third secondary connector 15C and in FIG. 1D a fourth secondary connector 15D, all of which enable various functions of the supply cable 10. All secondary connectors 15A, 15B, 15C, 15D herein have, by way of example, cable connection point 2 for electrical connection to the coupling 6. The secondary connectors 15A, 15B, 15C, 15D can therefore be easily and cost-effectively replaced by simply disconnecting the connection between coupling 6 and cable connection point 2.

The infrastructure connection point 1A of the first secondary connector 15A is used for the indirectly or directly releasably wireless or wired electrical connection to energy supply device 16, in which case the energy supply device 16 comprises its own charging control logic 33.

Said electrical connection can, e.g., be made via contact elements, e.g. plug contacts, or capacitively or inductively (e.g., by coils). The same applies to the electrical connection between cable connection point 2 and coupling 6, a directly or indirectly releasable electrical connection is preferably provided here, which can be wireless or wired. The infrastructure connection point 1A of the first secondary connector 15A is, e.g., a Type 2 connection point for connection to a charging column or wallbox.

In the configuration shown in FIG. 1B, the supply cable 10 comprises the second secondary connector 15B. The second secondary connector 15B comprises a plug-in connector 1B designed to electrically connect to an energy supply device 16 without its own charging control logic 33. The energy supply device 16 shown in FIG. 1B is, e.g., a permanent voltage source, e.g. a household power outlet, e.g. a Schuko power outlet which, e.g., enables single-phase charging, or a three-phase power outlet, etc.

In the configuration shown in FIG. 1C, the supply cable 10 comprises the third secondary connector 15C. The third secondary connector 15C comprises a power outlet 1C via which electrical energy can be drawn from the vehicle 12, in particular the energy storage unit 11. The power outlet 1C is, e.g., a Schuko power outlet or a three-phase power outlet, etc. The power outlet 1C is used for releasable electrical connection to an electrical consumer 30 (in this case, by way of example, a hair dryer).

In the configuration shown in FIG. 1D, the supply cable 10 comprises the fourth secondary connector 15D. The fourth secondary connector 15D comprises an additional vehicle connection point 1D, via which electrical energy can be drawn from the vehicle 12, in particular the energy storage unit 11. The additional vehicle connection point 1D is, e.g., identical to the vehicle connection point 14A of the primary connector 14. The additional vehicle connection point 1D is used for releasable electrical connection with a further vehicle 12A, which comprises a further energy storage unit 11A. The further energy storage unit 11A can therefore be charged using electrical energy from the energy storage unit 11.

Given that the first secondary connector 15A, the second secondary connector 15B, the third secondary connector 15C and the fourth secondary connector 15D all comprise the cable connection point 2, all of these secondary connectors 15A, 15B, 15C, 15D can be easily replaced and used on the same coupling 6 of the supply cable 10. The supply cable 10 can therefore be quickly and easily brought into a desired configuration to perform a desired function by simply replacing the secondary connector 15A, 15B, 15C, 15D.

The connecting line 13 between the coupling 6 and the additional coupling 5 in this exemplary embodiment comprises only electrical conductors that make an electrical connection between the coupling 6 and the additional coupling 5. These electrical conductors are, e.g., copper conductors or aluminum conductors, or are made of another material of high electrical conductivity and comprise electrical insulation. All electrical conductors are, by way of example, gathered together into one strand and preferably comprise a common sheath, which on the one hand serves as electrical insulation and on the other hand as mechanical protection. Preferably, no active or passive electrical component is provided in the connecting line 13, e.g. no ICCB. All logical components or logic components (e.g., microprocessors, ASICs, etc.) and in particular active or passive electrical components are either part of the primary connector 14 or part of the secondary connector 15A, 15B, 15C, 15D. The connecting line 13 can as a result be manufactured and also replaced at an advantageous cost.

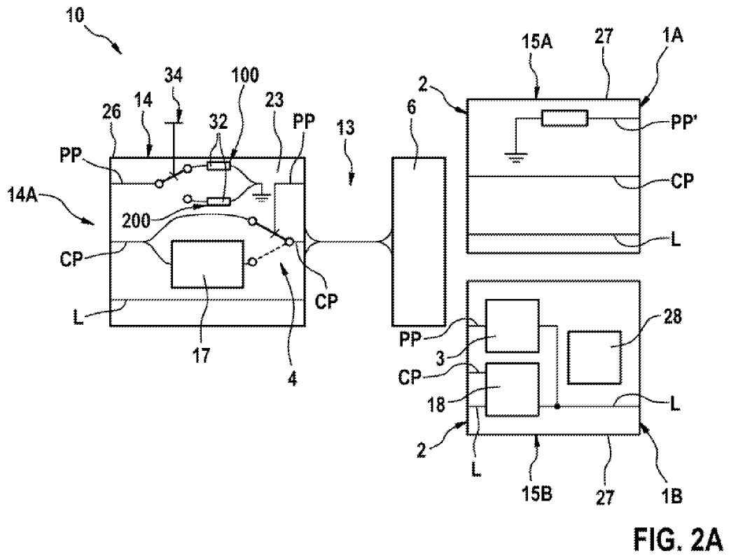

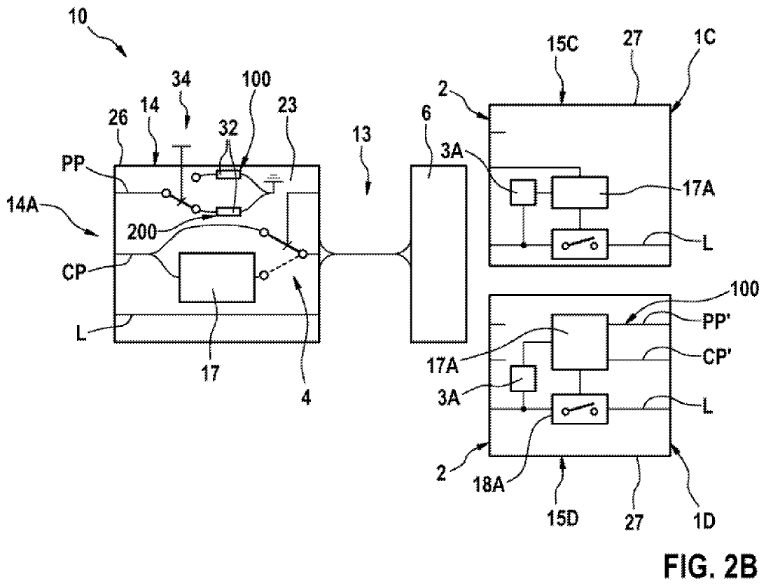

FIG. 2A schematically shows an overview of the operation as well as the construction of the supply cable 10 in the two configurations in which the energy storage unit 11 of the vehicle 12 is to be charged. FIG. 2B schematically shows an overview of the operation as well as the construction of the supply cable 10 in the two configurations in which the energy storage unit 11 of the vehicle 12 is to be used as the source of electrical energy (discharge). In the configuration shown in FIG. 2A and FIG. 2B, the additional coupling 5 of the connecting line 13 as well as the additional connection point 9 of the primary connector 14 are omitted. Rather, the connecting line 13 is guided directly into a first housing 26 of the primary connector 14. The connecting line 13 is, e.g. attached or connected in that location in a non-releasable (i.e., non-destructively releasable) manner. The connecting line 13 therefore only comprises the coupling 6, to which the various secondary connectors 15A, 15B, 15C, 15D can be attached, in particular in a non-destructively releasable manner. In principle, more than two different types of secondary connectors 15A, 15B, 15C, 15D can also be attached to the coupling 6. The various types of secondary connectors 15A, 15B, 15C, 15D enable—as previously described—on the one hand the connection to electrical consumers 30 or other vehicles 11A to be charged and, on the other hand, the connection to various energy supply devices 16, in particular to, e.g., a household outlet that permanently provides electrical energy but comprises no charging control logic 33, as well as to a dedicated charging infrastructure that already contains a corresponding charging control logic 33 and can enable multiphase charging or energy transfer.

As previously described, a plurality of transmission elements 8 is connected to the vehicle connection point 14A of the primary connector 14 (see FIGS. 3A, 3B). It is thereby provided that a status line PP of the supply cable 10 can be connected to the vehicle 12 via one of these transmission elements 8. A communication line CP of the supply cable 10 can be connected to the vehicle 12 via a further transmission element 8. The status line PP enables the vehicle 12 to detect that the supply cable 10 is connected to the vehicle 12. In addition, it is provided that the supply cable 10 is designed to have different characteristics at the status line PP in order to display the various configurations of the supply cable 10 and to provide and/or make them readable for a vehicle. The status line PP is designed to feature a first characteristic 100 which is indicative of a readiness of the supply cable 10 to transmit (charge) electrical energy to the vehicle 12, which is shown in FIG. 2A. Conversely, if the status line PP has a second characteristic 200, it indicates a readiness of the supply cable 10 or provides information for a vehicle to draw (discharge) electrical energy from the vehicle 12. The vehicle 12 is therefore able to recognize which action a user wishes to take. The user can easily use the same supply cable 10 for various applications, in which case the supply cable 10 can be configured differently using different secondary connectors 15A, 15B, 15C, 15D.

In addition to the status line PP and the communication line CP, the supply cable 10 also comprises a power line L, which in particular comprises at least one phase conductor L1, L2, L3, a neutral conductor N, and a protective ground PE. Details of the power line L are described below with reference to FIG. 3A and FIG. 3B.

In the exemplary embodiment in FIG. 2A and FIG. 2B, the first characteristic 100 and the second characteristic 200 are formed by various passive electrical components 32, shown in this case by electrical resistors, which can be switched by a switchover unit 34 in the primary connector 14.

It should be noted that, in one embodiment (not shown in detail in this case for reasons of clarity), the type of characteristic (i.e., either first characteristic 100 or second characteristic 200) can also be set depending on the type of secondary connector 15A, 15B, 15C, 15D coupled to the coupling 6.

Therefore, in the exemplary embodiment shown in this case, the user can simply and easily use the supply cable 10 to charge the energy storage unit 11 of the vehicle 12 by actuating the switchover unit 34 or draw energy from the energy storage unit 11 of the vehicle 12 by the supply cable 10. In FIG. 2A, the first characteristic 100 is present or set at the status line PP, which is indicative of a configuration of the supply cable 10 for charging the energy storage unit 11 of the vehicle 12. Therefore, either the first secondary connector 15A or the second secondary connector 15B is connected to the coupling 6 of the supply cable 10.

FIG. 2B shows an example of a configuration of the supply cable 10 for discharging the energy storage unit 11 of the vehicle 12. For this purpose, the second characteristic 200 is present or set at the status line PP, which indicates a drawing of energy from the energy storage unit 11 of the vehicle 12 or makes it readable for the vehicle. Therefore, either the third secondary connector 15C or the fourth secondary connector 15D is connected to the coupling 6 of the supply cable 10.

FIG. 2A shows a further status line PP′ of the first secondary connector 15A, which indicates to the charging control logic 33 of the energy supply device 16 that the infrastructure connection point 1A is connected to the energy supply device 16. In the example shown, the further status line PP′ is designed separately from the previously described status line PP, but can also be electrically connected to it.

In this embodiment—by way of example only—the primary connector 14 comprises a bypass switch 4 and a control unit 17. The bypass switch 4 can be switched between a first switching status and a second switching status, in which case the first switching status bypasses the control unit 17 (in FIG. 2A: the upper, solidly drawn path), whereas, in the second switching status the control unit 17 is connected to the electrical path of the supply cable 10 (in FIG. 2A the lower, dashed drawn path). The “bypassing” or “intermediate” is only shown schematically in this case. It should in this context be understood that, in the first switching status, the control unit 17 which can, e.g., be designed as an ASIC or microprocessor or as a printed circuit board with a circuit arranged thereon, is set to a status in which it cannot send or transmit control signals to the communication line CP. In the second state, in turn, preferably no signals can reach the vehicle connection point 14A directly from the coupling 6; instead, preferably only signals from the control unit 17 reach the vehicle connection point 14A.

In addition, in FIG. 2A and in FIG. 2B, the bypass switch 4 is only provided on one side and is only used to connect and disconnect a connection point of the control unit 17 to and from the coupling 6. Alternatively, the bypass switch 4 can also be present on both sides and can additionally connect or disconnect a connection between vehicle connection point 14 and control unit 17.

In the present exemplary embodiment, the bypass switch 4 is shown designed separately from the control unit 17—also for reasons of clarity. However, the bypass switch 4 can in principle also be integrated into the control unit 17. In this case, the first switching status is to be understood so that the elements of the control unit 17 required for the functional control are in any case bypassed with respect to the line in which the bypass switch 4 is arranged. On the part of the vehicle 12, the communication line CP is switchable between two different statuses by means of the bypass switch 4. In the first switching status of the bypass switch 4, communication by the vehicle 12 with the charging control logic 33 connected to first secondary connector 15A is enabled by means of the communication line CP and, in the second switching status of the bypass switch 4, communication by the vehicle 12 with the control unit 17 is enabled. The details of this switching operation are explained hereinafter in the description of FIG. 3A. The bypass switch 4 therefore enables the control unit 17 to be selectively activated or deactivated, in which case the switching between the first switching status and the second switching status is performed depending on the type of secondary connector 15A, 15B, 15C, 15D. This enables the supply cable 10 to optionally be used as an intelligent or active supply cable 10 (second switching status) or as a non-intelligent or passive supply cable 10 (first switching status), depending on whether charging control logic in the cable is required or desired or not due to the type of the secondary connector 15A, 15B, 15C, 15D. A user of the supply cable 10 preferably need not initiate any switching processes manually. Instead, the bypass switch 4 is preferably switched by the secondary connector 15A, 15B, 15C, 15D or depending on the connected secondary connector 15A, 15B, 15C, 15D or depending on the type of the connected secondary connector 15A, 15B, 15C, 15D. Therefore, the user need only attach or connect or couple the secondary connector 15A, 15B, 15C, 15D to the connecting line 13 suitable for the current charging situation, e.g. by means of the coupling 6, in order to configure the supply cable 10 suitable for the respective charging situation. Further intervention by the user can ideally be omitted.

When the first secondary connector 15A is coupled to the coupling 6, it is provided that a direct connection of the infrastructure connection point 1A to the coupling 6 is performed via the cable connection point 2. Details of this are again explained below with a description of FIG. 3A. If the first secondary connector 15A is used, the supply cable 10 is provided in particular for connection to a charging infrastructure as energy supply device 16. In this case, due to the charging control logic 33, no own logic is required within the supply cable 10, which is why the control unit 17 is bypassed by the bypass switch 4. The supply cable 10 is therefore used as a non-intelligent or passive supply cable and enables communication by the energy storage unit 11 or the vehicle 12 directly with the charging control logic 33 of the energy supply device 16 via the communication line CP.

Conversely, if the second secondary connector 15B is used, then the plug-in connector 1B is used for connection to a charging point, which can be designed without charging control logic. This can in particular relate to the connection to a household power outlet, for example via a Schuko plug, e.g., designed for each country. In this case, no charging control logic and also no communication or signal line is provided by the energy supply device 16, which is why in this exemplary embodiment a plurality of active components are arranged within the second secondary connector 15B. Also in this case, the control unit 17 (in the primary connector 14) is required as a charging controller for the charging process or the power transfer process. Therefore, the bypass switch 4 is switched to the second switching status in order to avoid bypassing the control unit 17 and to integrate the control unit 17 into the electrical path of the supply cable 10, i.e. the communication line CP.

It is understood that, in principle, a second secondary connector 15B can also be used when using the energy supply device 16 described above with its own charge control logic 33. This can be desirable, for example, if the user expects advantages from the fact that the energy transfer is not performed by direct communication of the vehicle 12 or the energy storage device 11 with the charging control logic 33 of the energy supply device 16, but instead the control unit 17 is to be deliberately used for communication with the vehicle 12.

It should further be understood that the switching of the bypass switch 4 can be achieved in a variety of ways. It is advantageous that said switching is performed depending on the first secondary connector 15A and the second secondary connector 15B. One embodiment, which should be understood by way of example only, is described hereinafter and shows how the bypass switch 4 can be switched depending on type. Of course, other embodiments are also conceivable (e.g., by wireless or wired transmission of information about the type of second connection device), in which case the setting of the respective switching status is then based on the transmitted or received or read-out information.

The second secondary connector 15B in this case only comprises an exemplary voltage supply 3 and a switching unit 18. If a connection of the plug-in connector 1B of the second primary connector 15B to the energy supply device 16 takes place, the switching unit 18 initially remains open, whereby the cable connection point 2 is initially disconnected from voltage-thus advantageously also reduces a risk to an operator if the connecting line 13 is not yet connected. The connecting line 13 and the primary connector 14 are therefore not electrically directly coupled to the energy supply device 16. The voltage supply 3 only provides a supply voltage, which in this case is in particular a DC voltage. The voltage supply 3, which can, e.g., be an AC/DC converter provides the supply voltage via the coupling 6 and the connecting line 13 to the bypass switch 4 and/or the control unit 17 (in the primary connector 14), e.g. via the status line PP. The supply voltage can, e.g., be in a range between 5 V and 40 V, preferably between 10 V and 30 V.

Therefore, either by the presence of the supply voltage, the bypass switch 4 can be switched directly by, e.g., designing the bypass switch 4 as relays, MOSFET, or the like. Alternatively, the bypass switch 4 can also be switched by the control unit 17, in which case the control unit 17 is first supplied with electrical power by the voltage supply 3 and then switches the bypass switch 4 (to the second switching status). In both exemplary cases, the control unit 17 therefore becomes active and can subsequently control the charging process of the energy storage unit 11. The control unit 17 can, for example, also be configured to output a corresponding signal to the switching unit 18 in order to establish the electrical connection between energy supply device 16 and energy storage unit 11 (the power path between coupling 6 energy supply device 16 is closed, charging current can flow). Preferably, the control unit 17 also communicates with the vehicle 12 or the energy storage unit 11 of the vehicle 12 after its activation (bypass switch 4 in the second switching status), and causes the vehicle 12 or the energy storage unit 11 to, e.g., transfer maximum current during energy transfer, or more specifically: not to exceed the charging current. The charging control is therefore performed between the control unit 17 and the vehicle 12 or its energy storage unit 11. In this way, the control unit 17 assumes the function of the charging control logic 33 of the power supply 16 not present in this application.

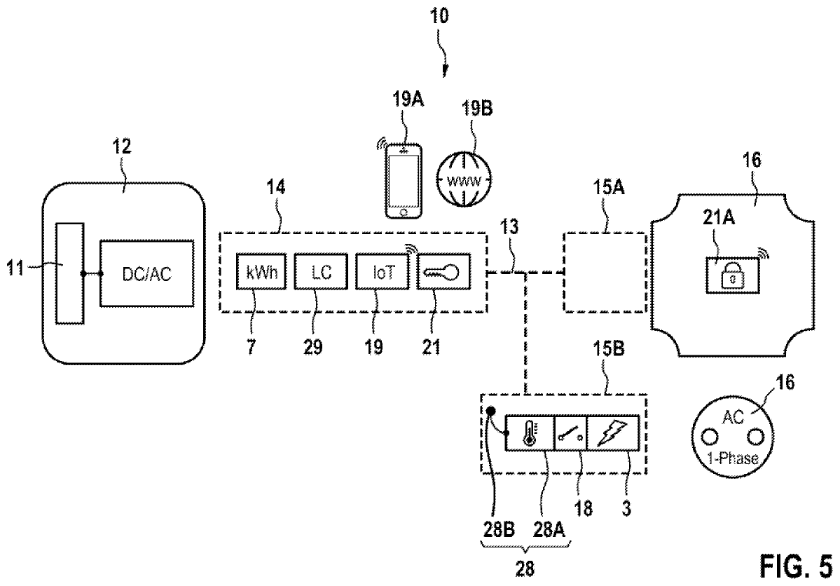

Particularly advantageous, the second connection device or secondary connector 15B also comprises a temperature monitoring module 28. The temperature monitoring module 28 is used for reading and/or determining or sensing a temperature of the second connection device or secondary connector 15B, such that overloading of the second secondary connector 15B due to too high temperatures can be prevented. The mode of action of the temperature monitoring module 28 is explained further below with a description of FIG. 5.

It is understood that the bypass switch 4 can also be arranged in the connecting line 13.

FIGS. 3A and 3B also show a schematic design of the supply cable 10, with a greater degree of detailing than shown in FIGS. 2A and 2B. The bypass switch 4 is in this case—by way of example only and for the sake of clarity-again shown as separate from the control unit 17. In this exemplary embodiment, the additional coupling 5 of the connecting line 13 and the additional connection point 9 of the primary connector 14 are also shown, so that the primary connector 14 can be released from the connecting line 13. As previously described, a plurality of electrical conductors 13A, 13B, 13C, 13D, 13E, 13F, 13G extend between the additional coupling 5 and the coupling 6. The electrical conductors 13A, 13B, 13C, 13D, 13E, 13F, 13G are all designed here as an example, continuously between coupling 6 and additional coupling 5, and in particular not physically interrupted by other electrical components, or no other electrical components are arranged in the respective conductors 13A, 13B, 13C, 13D, 13E, 13F, 13G (i.e. also not ICCB). Therefore, no active or passive electrical component is present between the coupling 6 and the additional coupling 5. However, it is understood that the bypass switch 4 can, as previously mentioned, in some exemplary embodiments be, e.g., arranged in the connecting line 13

The primary connector 14, as previously explained, comprises a plurality of transmission elements 8 on the vehicle connection point 14A provided for electrical connection to the energy storage unit 11. Each energy transmission element 8 is associated with an electrical conductor 13A, 13B, 13C, 13D, 13E, 13F, 13G, each combination of transmission element 8 and associated electrical conductor 13A, 13B, 13C, 13D, 13E, 13F, 13G is provided for either transmitting a signal or transmitting an electrical charging power. In the exemplary embodiment shown, one of the conductors 13A is therefore used as the status line PP, one of the conductors 13B as the communication line CP, one of the conductors 13C as the first live phase L1, one of the conductors 13D as the second live phase L2, one of the conductors 13E as the third live phase L3, one of the conductors 13F as the neutral conductor N, and one of the conductor 13G as the protective earth PE. As previously described, the first phase L1, the second phase L2, the third phase L3, the neutral N and the protective earth PE are also partially combined as power line L. It goes without saying that a different number of conductors or a different arrangement of the conductors is also possible in principle.

In the first switching status, an electrical connection is established by the bypass switch 4 between at least one energy transmission element 8 and the respective associated electrical conductors 13A, 13B, 13C, 13D, 13E, 13F, 13G by bypassing the control unit 17 to form the communication line CP continuously between vehicle 12 and energy supply device 16. In the second switching status, the control unit 17 is electrically interposed between
the power transmission element 8 connected to the associated electrical conductors 13A, 13B, 13C, 13D, 13E, 13F, 13G in the first switching status via the bypass switch 4 and
the respective associated electrical conductor(s) 13A, 13B, 13C, 13D, 13E, 13F, 13G,
to form the communication line CP between vehicle 12 and control unit 17 for controlling a power transfer operation, e.g., a charging process. The electrical conductors 13C, 13D, 13E, 13F, 13G forming the power line L as well as the associated energy transmission element 8 are permanently connected in this exemplary embodiment when a connection between additional coupling 5 and additional connection point 9 is established.

Like FIG. 2A, FIG. 3A shows two configurations of the supply cable 10 for charging the vehicle 12. The bypass switch 4 is, for example, in the first switching status by default. If—as shown in FIG. 3A top right—the first secondary connector 15A is used and electrically coupled to the coupling 6 of the connecting line 13, the end result is a (direct) electrical connection between the energy transmission element 8 (on the vehicle side) and the infrastructure connection point 1A of the first secondary connector 15A, bypassing the control unit 17. For example, the control unit 17 is not supplied with electrical power and remains inactive. Communication between energy storage unit 11 or vehicle 12 and energy supply device 16 or charging control logic 33 is enabled via the communication line CP formed by the respective conductor 13B, as it is directly connected by the bypass switch 4 by bypassing the control unit 17.

If, on the other hand, the second secondary connector 15B is used (see FIG. 3A, bottom right), the control unit 17 is advantageously used and switched actively. By way of example only, the second secondary connector 15B connected to a conventional household power outlet, e.g. a Schuko power outlet comprising a neutral conductor N, a phase conductor L1, and a protective conductor PE.

In this case activation of the control unit 17 is, by way of example only, performed by the second secondary connector 15B first providing a supply voltage via the voltage supply 3, which is output to the control unit 17 via the corresponding conductor 13A of the status line PP. In this case, the voltage supply 3 converts, e.g., an AC current from the energy supply device 16 into (by way of example only) a DC voltage, e.g. a DC voltage between 5 V and 50 V, preferably between 10 V and 25 V. The control unit 17 is therefore supplied with electrical power and is therefore active. In addition, the bypass switch 4 is switched to the second switching status so that the communication line CP can be actuated by the control unit 17. The switching of the bypass switch 4 can either be performed via the supply voltage of the voltage supply 3 or, alternatively, via an actuation signal of the control unit 17. It is understood that other embodiments are also possible for causing the bypass switch 4 to switch so that the control unit 17 is activated or not bypassed when the second secondary connector 15B is connected to the supply cable 10 or the connecting line 13. For example, the bypass switch 4 can be switched via a wirelessly transmitted signal or the like.

If the energy storage unit 11 and/or the vehicle 12 attempt to communicate via the communication line CP (e.g., towards the energy supply device 16), this communication is then only performed using the control unit 17. The control unit 17 can therefore function as a charging controller with respect to the energy storage unit 11 and/or the vehicle 12 and control the charging process. This comprises, in particular, negotiating a charging power expected by the energy storage unit 11 and/or the hybrid or electric vehicle 12.

As soon as the charging process is to be started, the switching unit 18 is (in this case, by way of example) actuated. This actuation of the switching unit 18 can, e.g. be performed for via the conductor 13B associated with the communication line CP. This conductor 13B is no longer directly connected to the associated energy transmission element 8 in its second switching status due to the bypass switch 4 and can therefore no longer receive any communication signals from the energy storage unit 11 and/or the vehicle 12. In other words, the control unit 17 can switched the switching unit 18 via the aforementioned conductor 13B of the connecting line 13 so that charging current can flow to the vehicle 12. The switching unit 18 is here, for example, switched to an open position by default. As a result, no power flows between vehicle 12 and energy supply device 16 initially. If, for example, it is a charging process, energy supplied by the energy supply device 16 is not passed on to the connecting line 13 and the primary connector 14. This is not done until the charging process is to be started. The control unit 17 therefore has full control of the charging process and can affect its start (switching unit 18 closed) and stop (switching unit 18 opened) via the switching unit 18. In a particularly advantageous embodiment, a charging current can also be set via the switching unit 18.

The supply cable 10 can therefore be connected to various energy supply devices 16, in which case the supply cable 10 functions as an intelligent or active supply cable as per external requirements or as a non-smart or passive supply cable. the charging process is thereby significantly simplified for a user because the user need only attach the matching secondary connector 15A, 15B provided for charging to the connecting line 13, or connect it to the connecting line 13. The supply cable 10 is then configured independently in order to achieve a desired energy transfer operation, e.g. a desired charging situation.

In addition to charging the energy storage unit 11, the supply cable 10 is also particularly advantageous for drawing electrical energy from the energy storage unit 11 of the vehicle 12. To this end, the switchover unit 34 is to be activated, for example, by the user in order to apply the second characteristic 200 to the status line PP. It is understood that this activation can be performed in multiple ways, e.g., by a manually operated switch or via a wirelessly transmitted switching command or the like.

Alternatively or additionally, in an embodiment not shown in detail in this case for the sake of clarity, the type of characteristic (i.e., either first characteristic 100 or second characteristic 200) can also be set depending on the type of secondary connector 15A, 15B, 15C, 15D that is coupled to the coupling 6. This advantageously results in relief for the user, who then no longer has to actuate the switchover unit 34 (or must do so only for, e.g., plausibility verification. The (automatic) setting of the characteristic of the status line PP depending on the type of the secondary connector 15 can occur, e.g., wirelessly by a transmitter in the secondary connector 15, which communicates with a receiver in the primary connector 14 or in the connecting line 13 or in the coupling 6. The setting of the characteristic 100, 200 of the status line PP depending on the type of secondary connector 15 can alternatively or additionally also be performed by wire, e.g. via the status line PP itself. For this purpose (by way of example only) a different electrical or electronic component, e.g. an electrical resistor, which can be tested (e.g., by the vehicle 12) can be installed in each type of secondary connector 15A, 15B, 15C, 15D. If, for example, the second secondary connector 15B described above is used, then the supply voltage can also be used to activate a resistance in the status line PP, e.g., through the bypass switch 4 or connect it to the status line so that the first characteristic 100 (“charging”) is recognized, and the supply voltage is not directly exposed to the transmission element 8 of the vehicle-side status line PP connected to the vehicle 12. In this case, such a switchable component (e.g. resistor) could be arranged and switchable in the connecting line 13, in the coupling 6 and/or in the primary connector 14.

FIGS. 2B and 3B show a different configuration of the supply cable 10 that enables drawing of electrical energy from the vehicle 12 and/or its energy storage unit 11. To draw electrical energy from the vehicle 12, the third secondary connector 15C and the fourth secondary connector 15D are provided, as shown in FIG. 2B and in FIG. 3B.

The third secondary connector 15C—as illustrated in FIGS. 2B and 3B shown on the upper right-comprises, e.g., a power outlet 1C, which is provided for connection to the consumer 30 (in principle, a plug-in contact would also be possible, but this may be unfavorable given safety considerations). The power outlet 1C is, e.g., a Schuko power outlet or a three-phase, high-power socket (see dashed phase conductors L2, L3) or another power outlet adapted to the regional design. If the third secondary connector 15C is connected to the coupling 6, then the supply cable 10 can be used to supply the consumer 30 with electrical energy from the vehicle 12, in particular the energy storage unit 11. The vehicle 12 provides this electrical energy when the second characteristic 200 is detectable at the status line PP, or is readable or present. Additionally, an additional control unit 17A can be provided, which is powered by an additional voltage supply 3A. This additional control unit 17A enables an additional switching unit 18A to switch to release the electrical energy supplied by the vehicle 12 at the power outlet 1C. In addition, it is advantageous that communication between vehicle 12 and additional control unit 17A be performed via the communication line CP.

The second characteristic 200 was in this case again set by the switchover unit 34 in the primary connector. However, said characteristic can also be set, e.g., by means of an electrical or electronic component connected to the status line PP in the third secondary connector 15C, e.g. a resistor (e.g., switched against neutral N). Said characteristic can, e.g., also be provided by a transmitter that transmits a signal to the second characteristic 200 which is, e.g. received in the primary connector 14 before the second characteristic 200 is set at the status line PP.

If the third secondary connector 15C is connected to the coupling 6, then no communication beyond the indication of the second characteristic 200 is required, so the previously described components of the additional control unit 17A, the additional voltage supply 3A, and the additional switching unit 18A can in principle also be omitted. In particular, no negotiation of varying amounts of current between the consumer connected to the third secondary connector 15C (e.g., a lawnmower, a hair dryer, a drilling machine, etc.) and the vehicle 12 or its battery 12 is necessary. Only a maximum drawable current can be specified or set. The supply cable 10 therefore acts as a non-smart or passive cable that does not perform any active communication or control.

The fourth secondary connector 15D—as illustrated in FIGS. 2B and 3B shown below right—enables energy to be transmitted from vehicle 12 to another vehicle 12A. This means that the further vehicle 12A is being charged. For example, an additional or further control unit 17A can be provided in the fourth secondary connector 15D, which enables communication with the further vehicle 12A to control the charging process. The additional or further control unit 17A can only be supplied with electrical power by means of an additional voltage supply 3A, by way of example, for example (optional), an additional switching unit 18A can be present, which initially interrupts an electrical connection of the power line L between vehicle 12 and further vehicle 12A. Only when the additional control unit 17A has negotiated the charging process with the further vehicle 12A does the additional switching unit 18A switched via the further control unit 17A in this exemplary embodiment so that a flow of energy from the vehicle 12 to the further vehicle 12A is enabled. Communication between the additional control unit 17A and the further vehicle 12A in this exemplary embodiment is via an additional communication line CP′, which is hereby separated from the communication line CP, as an example. Alternatively, the additional control unit 17A, the additional voltage supply 3A and the additional switching unit 18A can be omitted, in which case the communication line CP is designed directly between vehicle connection point 14A and additional vehicle connection point 1D. The vehicle 12 and the further vehicle 12A can thereby communicate directly and start and/or stop and/or control the charging process. In principle, however, a separation between the status line PP and an additional status line PP′ remains, since the status line PP indicates the first characteristic 100 to the vehicle 12 and that of an additional status line PP′ indicates the second characteristic 200 to the further vehicle 12A.

The fourth secondary connector 15D has a very similar construction and function as the primary connector 14. Control by the additional control unit 17A during the charging process of the further vehicle 12A is identical or at least very similar to control of the charging process of the vehicle 12 by the control unit 17, e.g., in the presence of the second secondary connector 15B (see the description of FIGS. 2B and 3B above).

In one advantageous embodiment, therefore, a further primary connector 14 can be used as the fourth secondary connector 15D (in this case, a primary connector 14 is connected at both ends of the connecting line 13, of which one has the function as primary connector 14 in the second energy drawing configuration and the second characteristic 200 at the status line PP and the other has the function as the fourth secondary connector 15D as the charging connector and the first characteristic 100 on the further status line PP′. In this example, the status line CP then cannot continuously switch between both vehicles 12, 12A. In this case, it is provided that the primary connector 14 which is intended to be used as the fourth secondary connector 15D can be switched to a status by the switchover unit 34 or by a additional switchover unit 34A, in which status said connector is usable as the fourth secondary connector 15D of another supply cable 10. In this status, this primary connector 14 exhibits the first characteristic 100 (“charge”) at the status line PP or an additional status line PP′, which is established between the primary connector 14 acting as the fourth secondary connector 15D and the further vehicle 12A. Additionally, in this primary connector 14, the control unit 17 is, e.g., activated (which now acts as an additional control unit 17A of a fourth secondary connector 15D—but an additional control unit 17A can also be provided, for example, that is activated by the switchover unit 24 or the additional switchover unit 34A), e.g. by switching the bypass switch 4 to the second switching status. Therefore, this primary connector 14, which can be connected to the further vehicle 12A, can be used for a second purpose: in a first application, it is used as a normal primary connector 14. In the described vehicle-to-vehicle connection, it is then used as the fourth secondary connector 15D. The supply cable 10, which comprises a primary connector 14 at each end, can thus, e.g., transmit power from a charged vehicle 12 to another vehicle 12A which, e.g., has a discharged battery.

If the owners of the two vehicles 12, 12A each carry a supply cable 10 as previously described, the connection between the vehicle 12 and the further vehicle 12A is simple and low-cost, since each owner will in any case carry a primary connector 14. If the primary connectors 14 are fixedly connected to the connecting line 13, the two connecting lines 13 can be connected or coupled to one another on their couplings 6, if necessary while connecting an adapter piece. In this way, a particularly practical, space-saving, cost-effective and easy-to-use supply cable 10 is created for several applications, which, when the supply cable 10 is distributed among many users, creates an additional function (vehicle-to-vehicle connection) without the individual user having to purchase and carry an additional secondary connector 15D.

Of course, the fourth secondary connector 15D can also be designed as a stand-alone secondary connector 15 that is not usable as a primary connector 14.

Furthermore, it is understood that when using a fourth secondary connector 15D, the primary connector 14 connected to the vehicle 12 must have the second characteristic 200 so that energy can be drawn from the vehicle 12.

The primary connector 14 comprises a first housing 26, as described above, which can be designed differently. In FIGS. 2A and 2B, a variant was shown in which both the transmission element 8 of the vehicle connection point 14A and the connecting line 13 are formed on the first housing 26. In the variant shown in FIGS. 3A and 3B, the primary connector 14 comprises a first housing 26 in which the vehicle connection point 14A and the additional connection point 9 are designed to connect to the additional coupling 5. Therefore, it is in particular achieved that all components of the primary connector 14 are arranged in a common housing, the first housing 26. The primary connector 14 therefore in particular comprises no cable stubs or the like in order to connect the connecting line 13. However, the connecting line 13 can alternatively also be directly and non-destructively releasably coupled to the primary connector 14. Preferably, this supply line 13 then extends between the primary connector 14 and the coupling 6 over at least 1 m, more preferably over at least 1.5 m, and more preferably over at least 2.5 m. It is thereby advantageously provided that the risk of the coupling 6 coming to rest on the floor, and thus in the area of dirt and moisture, is reduced.

The secondary connector 15A, 15B, 15C, 15D comprises a second housing 27, on which the cable connection point 2 and, depending on the type of secondary connector 15A, 15B, 15C, 15D (by way of example only), either the infrastructure connection point 1A (e.g., a type 2 plug for connection to a charging station), the plug-in connector 1B (e.g., for connection to a Schuko power outlet), the power outlet 1C, or the additional vehicle connection point 1D are formed. It can, by way of example, also be provided that (similar to the primary connector 14) all of the components in the secondary connector 15A, 15B, 15C, 15D are arranged in a common housing, the second housing 27. In particular, doing so avoids the need to provide a cable stub or the like.

If the supply cable 10 for charging (first characteristic 100) is connected to a switchable power outlet on the side of the energy supply device 16, the second secondary connector 15B can, e.g., bridge or omit the switching unit 18 or make it functionally unavailable (e.g., by means of electronics) or only in the event of a temperature increase as an emergency shutdown or emergency restriction. The control unit 17 can be configured to shut off or reduce the flow of current, in this case by means of, e.g., the switching function of the switchable power outlet or by communicating with the switchable power outlet for this purpose.

The passive electrical components 32 for setting the first characteristic 100 or the second characteristic 200 can also be achieved in the control unit 17 in another exemplary embodiment (not shown in this case). Said components can then also be connected to the status line CP. They can, e.g., receive information or signals (in a wired or wireless manner) via the secondary connector 15A, 15B, 15C, 15D that is connected to the coupling 6 and, depending on the type of secondary connector 15A, 15B, 15C, 15D, correspondingly provide the first or second characteristic 100, 200. In this case, it is not necessary to provide separate electrical components 32. For example, separate electrical resistors can be omitted, as shown in FIG. 2A and FIG. 2B.

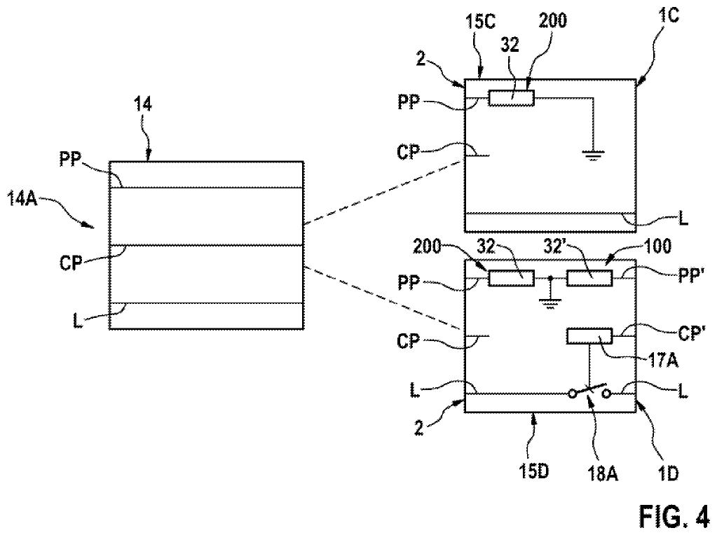

Previously, it was described and shown in FIGS. 2A to 3B that the setting of the first characteristic 100 and the second characteristic 200 is performed by the switchover unit 34. Alternatively, the setting of the first characteristic 100 and the second characteristic 200 can also be done via the secondary connector 15A, 15B, 15C, 15D, as shown by way of example using the third secondary connector 15C and the fourth secondary connector 15D in FIG. 4.

FIG. 4 shows another exemplary embodiment for the third secondary connector 15C and the fourth secondary connector 15D. The third secondary connector 15C and the fourth secondary connector 15D each have, as shown in FIG. 4, one, e.g. passive electrical component 32, which in the case shown here is e.g. a resistance. This (in the present case) passive electrical component 32 indicates the second characteristic 200, whereby the status line PP runs through the primary connector 14 and through the connecting line 13 to the passive electrical component 32. The vehicle 12 can therefore recognize the passive electrical component 32 at the status line PP or its resistance value, e.g., against earth or Read in or determine the mass. It can in this case be provided that, e.g., the passive electrical components 32 in the secondary connectors 15A, 15B, 15C, 15D are at least to the extent that the first characteristic 100 can be distinguished from the second characteristic 200. The first secondary connectors 15A and second secondary connectors 15B (not shown in FIG. 4) can, e.g., also have passive electrical components 32 or be configured to switch such a connection to the status line PP. The passive electrical components 32, which are connected to the first secondary connector 15A and the second secondary connector 15B or are arranged therein or can be switched to the status line PP by them, can be different from the passive electrical components 32, which are connected to the third secondary connector 15C and the fourth secondary connector 15D or are arranged therein or can be switched to the status line PP by them. An exemplary alternative design was described hereinabove for the second secondary connector 15B, in which the bypass switch 4—e.g., activated by the supply voltage—switches a component into the status line CP, which represents or represents the first characteristic 100. The user therefore need not operate any switchover unit 34. Instead, when the user connects the various secondary connectors 15A, 15B, 15C, 15D to the coupling 6, the appropriate characteristic 100, 200 is automatically configured at the status line PP.

An additional passive electrical component 32′ is preferably provided for the fourth secondary connector 15D. This additional passive electrical component 32′ is used to signal the first characteristic 100 to the further vehicle 12A because a charging is to be signaled to the further vehicle 12A in this case. To this end, as previously described, the further status line PP′ is designed, which is independent of the status line PP and faces or proceeds in the direction of the further vehicle 12A. In this way, various characteristics can be indicated on the vehicle connection point 14A of the primary connector 14 and on the additional vehicle connection point 1D of the fourth secondary connector 15D, on the additional vehicle connection point 1D the first characteristic 100 and on the vehicle connection point 14A the second characteristic.

FIG. 5 is a further illustration schematically showing the structure of the supply cable 10. In particular, the logical structure of the supply cable 10 is shown. It is understood that that the components shown in FIG. 5, all or in any combination, can also be provided in the exemplary embodiments previously described (not shown for the sake of clarity).

Advantageously, the primary connector 14 comprises an energy measuring module 7 in addition to the components previously described. The energy measurement module 7 is advantageously used to determine an electrical energy passed through the supply cable 10. For this purpose, the energy measuring module advantageously measures a current flow as well as an applied electrical voltage in order to first determine the electrical power flowing through the supply cable 10. The energy can be determined by sensing the power determined to be flowing during the respective period. This also enables a degree of aging of the supply cable 10 to be determined.

The primary connector 14 also advantageously comprises a display and/or input module 29. The latter can in particular be a touch screen or display or input device (e.g., comprising a keyboard or joystick or scroll wheel or rotary switch). The display and/or input module 29 can in particular be used to input and/or display a desired (maximum) charging current.

Furthermore, it is preferably provided that the primary connector 14 comprises a communication unit 19. The communication unit 19 is in particular a radio communication interface. The communication unit 19 is preferably for communication with a user terminal 19A (e.g., a mobile device, tablet, or a vehicle or its communication module, etc.) and/or the internet 19B. In this way, information about the charging process can be output to the user easily and reliably. At the same time, the user can (even remotely) provide inputs, e.g. the desired charging current specified hereinabove.

The primary connector 14 preferably also comprises an authentication module 21. The authentication module 21 enables authentication at the energy supply device 16, in particular during communication with an authentication opponent module 21A. Once appropriate authentication has been performed by the authentication module 21 and the authentication counter module 21A, the energy supply device 16 enables the transfer of electrical energy. On the one hand, doing so ensures that only authorized users can perform a power transfer between the vehicle 12 and the energy supply device 16. On the other hand, invoicing for the power transfer can be achieved in this way. As a result, a separate login of the user to the energy supply device 16 is not necessary. Instead, independent authentication and/or invoicing is performed by the authentication module 21, as well as the authentication counter module 21A, and thus ultimately by use of the primary connector 14. It can also be provided that authentication module 21 can be provided in first and/or second secondary connectors 15A, 15B.

The specified components, i.e., the energy measurement module 7, the display or input module 29, the communication unit 19, and the authentication module 21 simplify handling of the supply cable 10 for the user. Convenience functions such as the previously described invoicing can be performed easily and in a low-cost manner. The power transfer operation, e.g. a charging process, is therefore designed as simply as possible for the user.

If the supply cable 10 comprises the first secondary connector 15A and is therefore in the first configuration (first characteristic 100, “charge”) in order to be connected to a charging infrastructure, then further monitoring measures are often not necessary, but they are possible (see temperature monitoring for the second secondary connector 15B hereinafter). If the supply cable 10 comprises the second secondary connector 15B, or if this is connected to the connecting line 13 or coupled or connected to it, then-depending on the energy supply device used, e.g. a household power outlet, then only, e.g., single-phase charging is possible. In this case, advantageously, the temperature monitoring module 28 previously described is provided. The temperature monitoring module 28 in this case comprises, e.g., an evaluation circuit 28A and a temperature sensor 28B. The evaluation circuit 28A is connected to the temperature sensor 28B, in which case a temperature of the second secondary connector 15B can be sensed or determined by the temperature sensor 28B. The temperature sensor 28B can, e.g., be arranged nearby, or even inside, contact elements connected to the energy supply device 16. If, for example, a contact element is only poorly connected to the counter-contact element, due to the increased contact resistance and due to the high flowing currents, a sharp temperature increase on the contact element can be a sign of a risk that the counter-contact element or the energy supply device 16 can be damaged.

The temperature monitoring module 28 can perform various functionalities, as described hereinafter. Temperature monitoring is also preferably possible in the first secondary connector 15A, the third secondary connector 15C, and the fourth secondary connector 15D by in each case providing a temperature monitoring module 28 in the respective secondary connector 15A, 15B, 15C, 15D.

It is in this case understood that the temperature monitoring module 28 as such need not necessarily comprise the temperature sensor. Said module reads or determines temperature signals.

On the one hand, it can, e.g., be provided that the evaluation circuit 28A provides a status signal depending on a temperature that reads in the evaluation circuit 28A and that is sensed, e.g., by means of the temperature sensor 28B. The status signal can be transmitted via one of the electrical conductors 13A, 13B, 13C, 13D, 13E, 13F, 13G to the primary connector 14 and in particular to the control unit 17, but it can in principle also be transmitted wirelessly or via other lines.

The control unit 17 can therefore control the energy transfer operation, e.g. the charging process, based on the temperature information. The status signal can in particular indicate different temperature levels such that, e.g., different status signals are provided by the evaluation unit 28A as the temperature of the second secondary connector 15B moves within different predefined temperature ranges. In particular, a first status signal can indicate that the temperature is in a non-critical range. A second status signal can indicate that a temperature is in an elevated range, such that upon receipt of the second status signal, the control unit 17 can provide for a throttling of power flow (e.g., by notifying the vehicle 12 or the energy storage unit 11 to reduce the power flow or by impacting the switching unit 18). If, on the other hand, a third status signal is provided, it indicates that a predefined maximum temperature is exceeded, thereby stopping the charging process. The stopping of the charging process can be performed by the control unit 17 either by separating the current flow through the switching unit 18 and/or by notifying the vehicle 12 or the energy storage unit 11 that the energy transfer is to be ended. Alternatively, the stopping of the charging process can also be performed by the evaluation circuit 28A itself, either by the evaluation circuit 28A actuating the switching unit 18 or by the temperature monitoring module 28 comprising its own interrupt switch, which is actuable by the evaluation circuit 28A. In this way, it is achievable that a charging process only occurs in a predefined temperature range of the second secondary connector. As a result, it is advantageous to prevent overheating to potentially avoid a fire, in particular in the energy supply device 16 or infrastructure connected thereto.

1. A supply cable (10) for electrically connecting an energy storage unit (11) of a vehicle (12) both to an energy supply device (16), which provides electrical energy, and to a consumer (30), which requires electrical energy, said supply cable (10) comprising
a connecting line (13) having a coupling (6),
a primary connector (14) which is electrically coupled to the connecting line (13) and which has a vehicle connection point (14A) for releasably electrically connecting to the vehicle (12),
a secondary connector (15A, 15B, 15C, 15D) configured to releasably electrically connect to the energy supply device (16) or to the consumer (30),
wherein the coupling (6) of the connecting line (13) is configured to be releasably electrically connected to one of the various types of secondary connector (15A, 15B, 15C, 15D),
wherein the vehicle connection point (14A) has at least one transmission element (8), by means of which a status line (PP) of the supply cable (10) is or can be connected to the vehicle (12) in a wired or wireless manner,
wherein the status line (PP) is configured to have a first characteristic (100) indicating readiness of the supply cable (10) to transmit electrical energy to the vehicle (12),
wherein the status line (PP) is configured to have a second characteristic (200) indicating a readiness of the supply cable (10) to draw electrical energy from the vehicle (12), and
wherein the at least one secondary connector (15A, 15B, 15C, 15D) is configured to set either the first characteristic (100) or the second characteristic (200) at the status line (PP) depending on the type thereof
and/or
the primary connector (14) comprises a switchover unit (34), by means of which either the first characteristic (100) or the second characteristic (200) can be set at the status line (PP).

2. The supply cable (10) according to claim 1,
wherein the secondary connector (15A, 15B, 15C, 15D) is configured as a first secondary connector (15A), which is configured to electrically contact an energy supply device (16) having its own charging control logic (33),
and/or
wherein the secondary connector (15A, 15B, 15C, 15D) is configured as a second secondary connector (15B), which is configured to electrically contact an energy supply device (16) not having its own charging control logic and/or having a consistently provided electrical voltage,
and/or
wherein the secondary connector (15A, 15B, 15C, 15D) is configured as a third secondary connector (15C), which comprises a power outlet (1C) for an electrical plug-in connection to the consumer (30),
and/or
wherein the secondary connector (15A, 15B, 15C, 15D) is configured as a fourth secondary connector (15D), which is configured to electrically contact a further vehicle (12A).

3. The supply cable (10) according to claim 2,
wherein the vehicle connection point (14A) comprises a transmission element (8), by means of which a communication line (CP) of the supply cable (10) can be connected to the vehicle (12) in a wired or wireless manner.

4. The supply cable (10) according to claim 3,
wherein the first secondary connector (15A) comprises an infrastructure connection point (1A) for connection to the energy supply device (16), and the communication line (CP) is established directly between the vehicle connection point (14A) and the infrastructure connection point (1A) to enable direct communication between the charging control logic (33) of the energy supply device (16) and the vehicle (12).

5. The supply cable (10) according to claim 3,
wherein the primary connector (14) and/or the connecting line (13) comprise(s) a control unit (17) and a bypass switch (4), wherein the control unit (17) is configured to communicate with the vehicle (12),
wherein the bypass switch (4) is configured to disconnect at least one connection point of the control unit (17) from the communication line (CP) in a first switching status and to connect the at least one connection point of the control unit (17) to the communication line (CP) in a second switching status,
wherein the bypass switch (4) remains in the first switching status in the absence of actuation, and
wherein the second secondary connector (15B) is configured to actuate the bypass switch (4) in order to switch to the second switching status.

6. The supply cable (10) according to claim 5,
wherein, in the first switching status of the bypass switch (4), an electrical connection between the at least one connection point of the control unit (17) and the coupling (6) and/or the vehicle connection point (14A) is interrupted and, simultaneously, the communication line (CP) between the vehicle connection point (14A) and the coupling (6) is continuously established, and
wherein, in the second switching status of the bypass switch (4), the control unit (17) is electrically switched between the vehicle connection point (14A) and the coupling (6).

7. The supply cable (10) according to claim 5, comprising a microcontroller, wherein the electronic component comprises the control unit (17) and the bypass switch (4).

8. The supply cable (10) according to claim 5,
wherein the second secondary connector (15B) comprises a voltage supply (3) and a plug-in connector (1B) for connection to the energy supply device (16),
wherein the voltage supply (3) is electrically coupled to the plug-in connector (1B) and, when an electrical voltage is applied to the plug-in connector (1B), provides an electrical supply voltage that can be output to the control unit (17) and/or that is connectable to the bypass switch (4) in order to switch the bypass switch (4) to the second switching status, and
wherein the second secondary connector (15B) preferably comprises a switching unit (18), which is controllable by the control unit (17) and by means of which an electrical connection between the plug-in connector (1B) and the coupling (6) can be switched on and off, to control a charging process.

9. The supply cable (10) according to claim 5,
wherein the switchover unit (34) or an additional switchover unit (34A) of the primary connector (14) is configured to switch the bypass switch (4) to the second switching status and/or to activate the control unit (17) in addition to setting the first characteristic at the status line (PP) so that the primary connector (14) can be used as the fourth secondary connector (15D) of another supply cable (10).

10. The supply cable (10) according to claim 3,
wherein the fourth secondary connector (15D) comprises an additional vehicle connection point (1D) for connection to the further vehicle (12A), and wherein
either the secondary connector (15D) comprises a further control unit (17A) and the fourth secondary connector (15D) forms a separate additional communication line (CP′) between the further control unit (17A) and the additional vehicle connection point (1D) for communication between the further control unit (17A) and the further vehicle (12A),
or the communication line (CP) runs uninterrupted between the fourth secondary connector (15D) and the primary connector (14) to enable direct communication between the vehicle (12) and the further vehicle (12A).

11. The supply cable (10) according to claim 1, wherein the first characteristic (100) and/or the second characteristic (200) are realized by a passive electrical component (32) of the primary connector (14) or the secondary connector (15A, 15B, 15C, 15D), and/or
by signals from a control device of the primary connector (14) or the secondary connector (15A, 15B, 15C, 15D).

12. The supply cable (10) according to claim 1, wherein the first characteristic (100) and/or the second characteristic (200) have a plurality of sub-characteristics each indicative of a maximum current carrying capacity of the supply cable (10).
